(19) United States
(12) Patent Application Publication
(10) Pub. No.: US 2007/0113473 A1
(43) Pub. Date: May 24, 2007

(54) Circular retaining device for landscaping

(76) Inventors: James Sellers SR., Ocean Springs, MS (US); James Murray, Mobile, AL (US)

Correspondence Address: MARK O. LOFTIN, 1990 BRADSHIRE DR., MOBILE, AL, 36695, US

(21) Appl. No.: 11/282,054

(22) Filed: Nov. 18, 2005

(51) Int. Cl. A01G 9/02

(52) U.S. Cl. 47/65.5

(57) ABSTRACT

A circular ring for retaining landscape materials around the base of trees, shrubs or other objects is presented having a flat, flexible bottom and a detachable, single vertical side wall around the outer periphery. The side wall is held in place around the periphery of the bottom piece by a plurality of securing tabs that extend below the bottom side of the side wall. The plurality of pointed securing tabs is inserted into and through a matching plurality of small slits in a circular pattern around the bottom's periphery. An arc-shaped slit is cut into the upper mid-section of the securing tab to provide a retaining flap. Notches are placed into the upper corners of the securing tabs to effectively lock the side wall to the base once the securing tabs are inserted. Once inserted, the securing tabs are bent by the user to further secure the side wall to the circular base.

### BACKGROUND OF THE INVENTION

The present invention relates to a device placed on the around around the base of an object, such as a tree or shrub, for retaining decorative landscaping materials.

Landscape apparatus of many types and configurations have been utilized around the base of trees and shrubs to suppress undesirable overgrowth on the ground surface. (See U.S. Pat. No. 5,794,378). Such devices also protect the object they are placed around from being damaged by overgrowth trimming equipment, such as lawnmowers and weed-eaters. Several such apparatus also incorporate a means for retaining landscaping materials, such as mulch or decorative rock, around the base of the object. U.S. Pat. No. 5,711,106, for example, provides an inverted V-shaped wall for retaining landscaping materials. The majority of such devices are circular in shape and have a vertical circular side wall of a few inches in height.

The prior art landscape retaining/edging products are generally manufactured from plastic that its molded to conform to the inventor's preferred shape. Significant economic advantage can be obtained by limiting the assembly labor in addition to having the greatest amount of flexibility with regard to variety of ground conditions, tree/shrub base diameters, and landscape fillers to be used, all at a reasonable cost. Of the devices presently known in the art, manufacturing typically requires the high cost of developing molds from which the product can fabricated by injection of molten plastics (“injection molding” process). The high cost of injection molding (mold manufacturing, plastic melting, etc.) however typically results in a prohibitive cost to the consumer and poor economy to the inventor and manufacturer. What is needed in the art is a landscape edging device that can provide the strength and durability of an injection molded device, but be cut directly from plastic sheets using low-cost die pressing. The inventors present a device designed to be fabricated from a plurality of sub-components cut from flat material sheeting and held together with conventional fasteners. This design allows the landscape edging device to be fabricated in various sizes and from various different materials, colors and textures. Additional novel features are incorporated that provide critical strength to withstand heavy, coarse landscape materials and the harsh outdoor environment. The inventors also incorporate in the device a means for collecting and distributing water to the area around the retaking ring, which promotes lateral root growth for trees and shrubs.

### DESCRIPTION OF THE DRAWINGS

FIG. 1 presents a three-dimensional side view of the assembled circular retaining device for landscaping of the present device.

FIG. 2 presents a top view of the base plate of the present invention to show the various slits in the base plate for receiving the edging pieces.

FIG. 3 presents a side view of an edging piece comprising the side wall of the present device.

FIG. 4 presents a cross-sectional side view of the edging piece inserted into the base plate with the bottom of the tab of the edging piece bent into place and with the securing insert pushed into place.

FIG. 5 presents an enlarged view of one end of the edging piece shown in FIG. 4. to show features of the locking tabs.

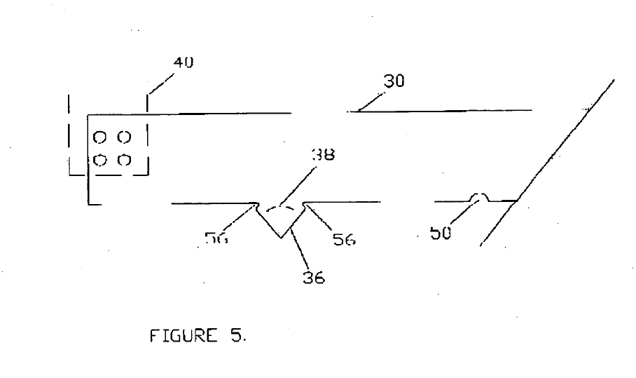

### DETAILED DESCRIPTION OF THE DRAWINGS

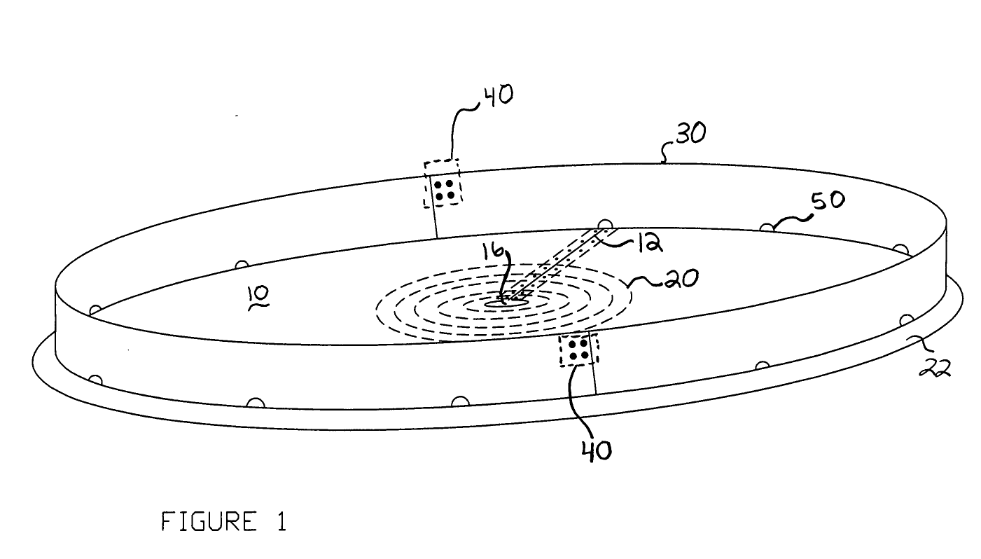

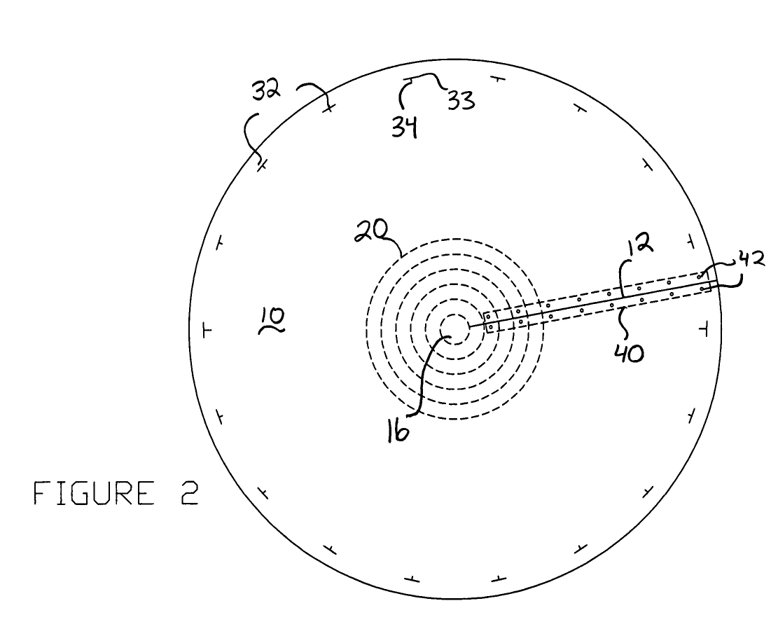

Referring to the drawings, FIGS. 1 through 4, where numerals represent corresponding parts for all drawings, FIG. 1 shows one embodiment of the device. This drawing shows a thin, flexible circular base 10 with a central circular aperture 16 to receive the base of a tree, shrub or other object. A slit 12 in the circular base 10 runs radially from the edge of the central aperture 16 to the outer edge of the circular base. This slit provides a means for allowing the circular base to be placed around the tree, shrub or object. A side wall 30 is shown attached to the circular base 30 forming a circle around the periphery of the circular base. In one embodiment, the side wall 30 is formed from two flexible strips of materials that are secured together by overlapping the ends and insertion of a suitable fastener through a plurality of holes 40 However, for smaller circular base diameters, a single side wall strip may be used. FIG. 1 also shows a plurality of perforated rings 20 extending outwardly from the central circular aperture that assist the user in enlarging the central circular aperture to accommodate larger base diameters of the object the present invention is placed around. The circumference created by the side wall 30 is slightly less than the overall outer diameter of the circular base 10 to create an outer lip 22. This outer lip 22 prevents the growth of ground flora directly adjacent to the side wall and aids in trimming the flora without adversely impact the side wall. The outer lip 22 is also formed as a result of locating the side wall attachment points 32 (See FIG. 2.) in from the outer edge of the circular base 10 to increase the strength of the side wall retention means.

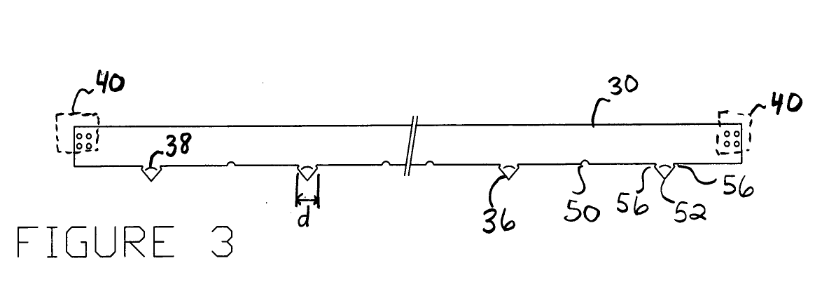

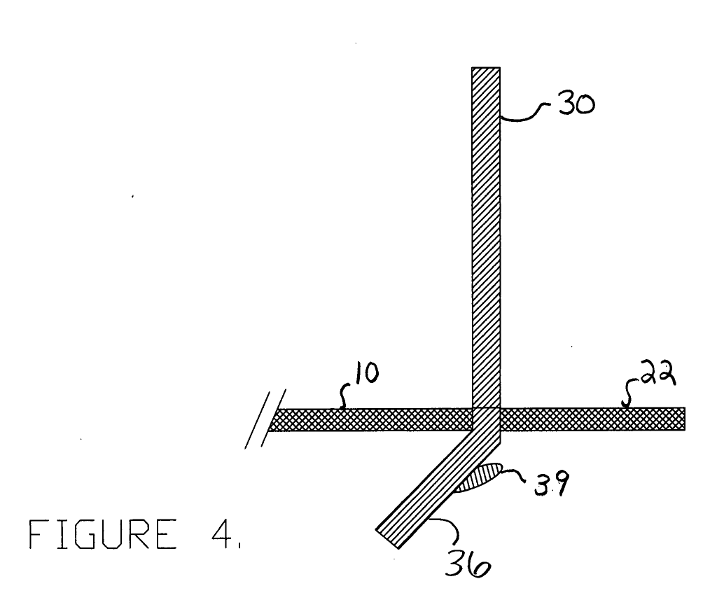

FIG. 2 shows a plan view of the circular base 10 without the side walls. This view shows a plurality of attachment points 32 placed along a circular pattern of diameter slightly less than the outer diameter of the circular base 10. These attachment points are comprised of a short slit 33 into the circular base 10 running tangential to diameter of said circular pattern. A shorter slit 34 is cut into the circular base that starts at the mid-point of the tangential slits 33 and runs radially inward towards the center of the circular base 10 at a distance approximately ½ of the width of the tangential slit 33. The purpose of this radial slit is to aid in separation of the tangential slit when the side wall securing tabs 36 are inserted. The tangential and radial slits receive the plurality of securing tabs 36 which extend below the bottom edge of the side wall 30 (See FIGS. 3 and 4).

FIG. 2 also shows the slit 12, which runs from the center of the circular base 10 extending radially outward to the outer edge. To provide structural strength to the circular base 10 after it is placed around the base of object being protected by the present invention, a fastening strip 40 is placed under the circular base 10 and centered along the radial slit 12. The fastening strip 40 includes a plurality of holes 42 which have matching holes in the circular base. A suitable fastener is inserted into the hole on the circular base and extends through the corresponding hole in the fastening strip 40. The fasteners and fastening strip may be removed to allow the user to resize the central aperture for adapting the device to trees, shrub or objects of varying base diameter.

FIG. 3 shows a side view of the side wall 30 separated from the circular base 10. A plurality of securing tabs 36 extends below the bottom edge of the side wall 30. The number of securing tabs matches the number of tangential 33 and radial slits 34 in the circular base 10. Each securing tab is comprised of a pointed bottom edge 52 and a pair of rounded notches 56 located on either side of the securing tab 36 at the bottom edge of the side wall 30. An arc-shaped slit 38 is cut into the top section of the securing tab 36 that aids in retaining the side wall to the circular base 10. The width d if the securing tab is measured as furthest linear extent across the securing tab, which is from the upper point of the rounded notch 56, across the width of the securing tab, to the upper point of the rounded notch on the other side of the securing tab. The width d of the securing tab is made just slightly larger than the length of the tangential slit 33 in the circular base 10. When the two upper points pass through the tangential slit 33, the slit slightly stretches then returns to lock circular base into the pair of rounded notches 52. The bottom edge of the side also contains a plurality of semi-circular shaped notches or holes 50 where water can flow out of the central space. These holes direct water to the outer rim of the present invention, which promotes lateral root growth and prevents water from collecting and standing inside the side wall area.

In one embodiment, the side wall is formed from a single piece of flexible material, such as a thermoplastic sheeting, and joined on the ends by an attachment means, such as a plastic rivet fastener, to form a circle around the periphery of the circular base 10. In another embodiment, the side wall 30 is formed from two pieces of flexible material, each foiling a half-circle, aid joined on the ends by an attachment means to form a continuous side wall around the periphery of the circular base 10.

FIG. 4 shows a cross-sectional view of the side wall 30 inserted into the circular base 10. One of the plurality of securing tabs 36 is shown inserted through the tangential 33 and radial 34 slits in the circular base 10. Once through the circular base, each securing tab 36 is bent in a direction either toward or away from the axis of the circular base 10. When the securing tab 36 is bent, the arc-shaped slit 38 allows a piece of the securing tab material to protrude and create a retaining flap 39 that extends out at an angle different from the angle formed by the side wall 30 and the rest of the securing tabs 36.

The retention of the side wall to the circular base 10 is greatly strengthened by three specific means: 1) contact between the upper points of the rounded notches 56 in the securing tabs against the underside surface of the circular base 10, 2) contact between the securing tab 56 body and the underside of the circular base 10 after bending the securing tab to some angle, and 3) contact between the retaining flap 39 and the underside of the circular base 10. Also, after bending the securing tabs under the circular base, the pointed edges aid in securing the whole assembly to the ground of other surface by contacting the ground.

Except for the fastening means, the present invention can generally be fabricated from cutting flat thin sheets of material using a die press. In one embodiment, a durable thermoplastic material, such as high-density polyethylene with ultra-violet light stabilizers, is used. However, any durable, flexible and cuttable material could alternatively be used. A decorative molded trim could also be placed around the upper edge of the side wall 30 to improve the aesthetic appearance of the device. The circular base can be made to any overall diameter that is economically practical given the availability of starting sheet material. Typical dimensions include 24, 36 and 48 inches. The thickness of the circular base material and the side walls are minimized to reduce material cost. In one embodiment, the circular base is approximately 3/32 inch thick, which provides suitable strength but also enough flexibility to allow the base to conform to uneven and bumpy ground surfaces around the object. The side wall material thickness is also minimized to improve flexibility yet sufficiently thick to provide adequate strength to retain landscaping materials. In one embodiment, the side wall material thickness is approximately 1/32 of an inch. The side wall 30 can be of any height desired but is generally preferred to between 2 to 4 inches due to practical and aesthetic concerns.

While the above detailed description describes the present invention, it is understood that modifications, variations and alterations can be made without deviating from the scope and fair meaning of the subjoined claims.

What is claimed is:

1. A circular device placed on top of the ground or other surface around the base of a tree, shrub or other object for retaining landscaping materials comprising of
a flexible, circular base with a central opening to receive the vertically-extending component of an object,
a plurality of circular perforations into the circular base and extending at fixed diameters outward from the central opening,
a single radial slit extending from the axis of the central opening to the outer edge of the circular base for allowing the passage of the base or the vertical object into the central opening,
a single annular side wall extending vertically from the circular base forming a peripheral border having a flat top side, a flat bottom side and a plurality of securing tabs extending from the bottom side, a plurality of side wall fastening slits cut into the circular base along the circumference of the side wall for receiving the side wall securing tabs, and a plurality of evenly-spaced holes notched into the bottom side of the side wall for distributing water substantially uniformly around the outer periphery of the circular base.

2. The device of claim 1 wherein the side wall securing tabs further comprise
a bottom side having a pointed end for insertion into the plurality of side wall fastening slits,
a top side integral with the side wall,
notches on either side of the securing tab at the junction of the securing tab's top side and the bottom side of the side wall, and
an arc-shaped slit into the mid section of the securing tab to create a retaining flap when the securing tab is bent.
